(19) United States
(12) Patent Application Publication
(10) Pub. No.: US 2010/0155533 A1
(43) Pub. Date: Jun. 24, 2010

(54) COMPOSITE FORWARD PRESSURE BULKHEAD

(75) Inventors: Benjamin Scott McKinnie, Rose Hill, KS (US); David Eugene Barland, Sedgwick, KS (US)

Correspondence Address: HOVEY WILLIAMS LLP, 10801 Mastin Blvd., Suite 1000, Overland Park, KS, 66210, US

(73) Assignee: Spirit AeroSystems, Inc., Wichita, KS (US)

(21) Appl. No.: 12/343,075

(22) Filed: Dec. 23, 2008

(51) Int. Cl. B64C 1/10

(52) U.S. Cl. 244/121

(57) ABSTRACT

A forward pressure bulkhead for aircraft includes an energy dissipating material layer, a metallic or nonmetallic inboard skin with a porous filler material positioned within said layers. The energy and load distribution layer redistributes and disperses energy of impacts and penetrations. The porous filler material is a material having ligaments that collapse resulting in a densification of the porous filler material in response to impact loading or a compression force sufficient to cause failure of the combined assembly.

### FIELD OF THE INVENTION

The present intention relates to a pressure bulkhead for an aircraft. More particularly, the invention relates to an energy dissipating and absorbing forward pressure bulkhead. The bulkhead has an energy and load distribution layer, an energy absorbing filler material and a metallic or nonmetallic inboard skin layer. The composite forward pressure bulkhead is lightweight and has high-energy dissipating and absorption properties under impact conditions and reacts to cabin pressure and flight loads.

### BACKGROUND

In aircraft and marine applications, bulkheads provide structural support and rigidity to the structure. Bulkheads often have additional functions and are used to create flame propagation barriers, watertight compartments and impact or projectile penetration barriers.

The forward pressure bulkhead of an aircraft provide both structural support and rigidity and protects the structure aft of the bulkhead. Located at the front of the aircraft, one forward pressure bulkhead is located behind the nose of the aircraft and protects the antenna and other electronic equipment. The nose of the aircraft and the antenna and electronics housed within, are susceptible to impact or projectile damage created by bird-strikes or other foreign objections that become air borne in high winds and under take-off and landings conditions. Subsequent bulkheads follow the forward bulkhead and separate the cabin areas of the aircraft.

Conventional design bulkheads are constructed of a metal wall or plate, aluminum or steel, and reinforced using ribs or spars that are mechanically fastened to the plate of the bulkhead. Alternatively, composite bulkheads of carbon/epoxy or graphite epoxy may be used. These composite structures also utilize spars and ribs which may be either of composite or metallic structure. One disadvantage of both metallic and nonmetallic bulkhead designs, is that they require many components which must be mechanically fastened or adhesively bonded.

Another disadvantage of conventional bulkhead designs are their rigidity. As the aircraft undergoes pressurization during flight, the bulkhead undergo stress and strain. Over time, these stresses lead to fatigue cracking typically originating out of fastener holes of the base and spar/ribs of metallic bulkheads.

Both metallic and nonmetallic bulkheads are susceptible to high energy impact damage such as bird-strikes or foreign objects. It is not uncommon for a bird to travel through a bulkhead structure during a high-speed impact. This results in structural damage of the bulkheads and often damages the structures and electronics located behind the bulkhead. A disadvantage of carbon/epoxy composite bulkheads is that they typically splinter and absorb little of the impact energy. Metallic bulkheads deform and may twist or warp. Also, in crash conditions, the bulkhead structure may fail in compression, buckle, and absorb little crash energy.

Accordingly, there is a need for a lightweight, forward pressure bulkhead that has low structural weight, high structural strength and is capable of absorbing impact or crash energy that does not suffer from the problems and limitations of the prior art.

### SUMMARY

The present invention provides a forward pressure bulkhead that satisfies the required strength and rigidity for strength with inherent energy dissipating and absorbing properties while utilizing less components than tradition bulkheads. This is achieved by the configuration of a ballistic energy absorption layer, a porous, collapsible filler material layer and a third, gas impermeable layer of metallic or composite material. The energy and load distribution layer may be constructed of Kevlar® or other high-strength aramid synthetic fiber. Kevlar® and aramid fibers have low stiffness, are highly deformable until failure, and are capable of dissipating the energy of a projectile along the fibers and limiting the travel of the projectile.

A composite forward pressure bulkhead in accordance with an embodiment of the invention may comprise a porous filler material having high mechanical energy absorption properties available to shield surrounding structure during impact failure. The porous filler material further allows for the wicking of moisture condensation away from the inboard skin and thereby reducing the onset of corrosion.

Another exemplary embodiment of the present invention provides a lightweight forward pressure bulkhead having a high strength-to-weight ratio. An embodiment of the forward pressure bulkhead also provides increased stiffness with higher energy absorbing characteristics during failure by impact than conventional materials and designs. Likewise, the sandwich structure is inherently stiff and reacts to cabin pressure and inertial flight loads without the need for spar and rib supporting structure.

These and other important aspects of the present invention are described more fully in the detailed description below.

### DESCRIPTION OF DRAWINGS

A preferred embodiment of the present invention is described in detail below with reference to the attached drawing figures, wherein:

FIG. 1 is a front perspective view of a prior art aircraft forward pressure bulkhead;

FIG. 2 is a schematic drawing of a forward pressure bulkhead constructed in accordance with an embodiment of the invention;

FIG. 3 is cross-sectional view of the forward pressure bulkhead with a porous filler material constructed in accordance with an embodiment of the invention; and

FIG. 4 is a cross-sectional view of the porous filler material of the forward pressure bulkhead of FIG. 3.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

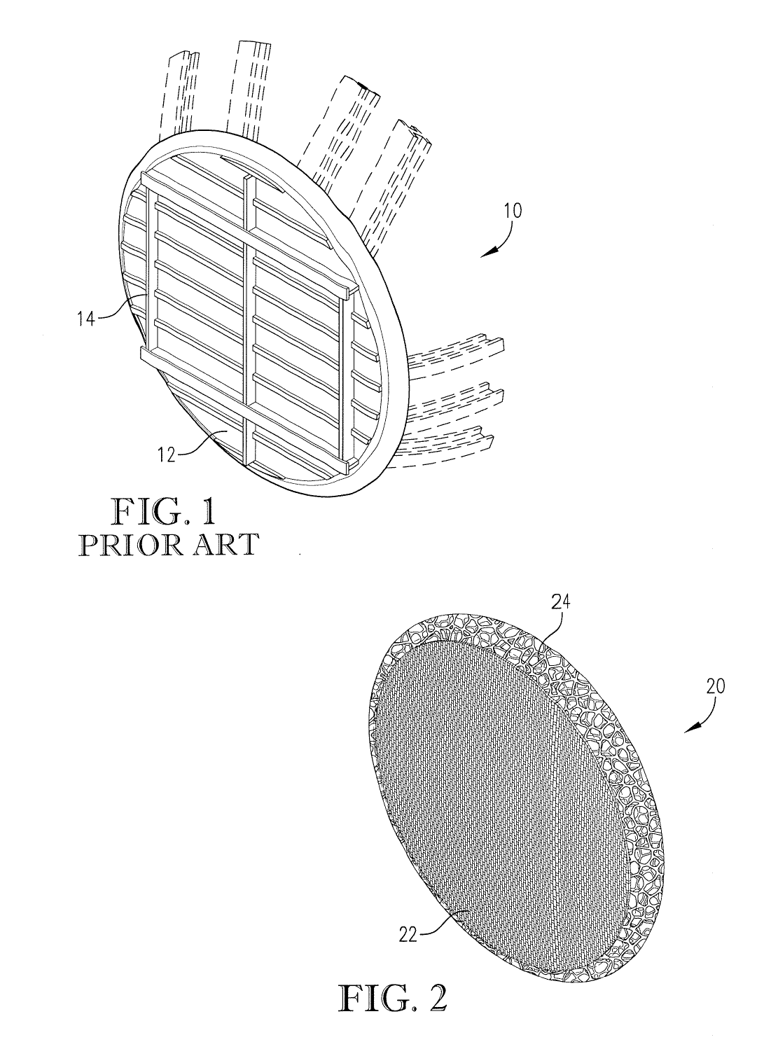

FIG. 1 illustrates a prior art forward pressure bulkhead 10 of conventional design having a base plate 12 and reinforcing spars 14 and ribs 16 construction. This configuration requires multiple components and fasteners.

FIG. 2 illustrates a composite forward pressure bulkhead 20 constructed in accordance with an embodiment of the invention and having an energy and load distribution layer 22 and a porous filler material 24. The composite forward pressures bulkhead 20 may be used as or incorporated in to aircraft. In one embodiment, energy and load distribution layer 22 may be composed of composite Kevlar® material fibers manufactured DuPont Corp in an epoxy resin. Alternatively, energy and load distribution layer 22 may be composed of similar aromatic polyamides or para-aramid synthetic fibers in an epoxy resin such as Nomexm also by DuPont, and Technoram by Teijin Limited of Japan. The thickness of energy and load distribution layer 22 depends upon the application. In one forward pressure bulkhead 20, the thickness of energy and load distribution layer 22 is approximately 0.040 inch.

The porous filler material layer 24 is adhesively bonded to energy and load distribution layer 22. Porous filler material layer 24 may be composed of various metallic or nonmetallic porous cores. One embodiment utilizes an aluminum metallic porous filler material such as Duocel® aluminum foam manufactured by ERG Materials and Aerospace, Inc. or alternatively, stabilized aluminum foam, (“SAF”) manufactured by Cymat, Co. of Canada. These porous filler materials of aluminum foam cores provide a metal skeletal structure wherein the foam contains a matrix of cells and ligaments that are regular and uniform throughout the foam. Various densities of foam, number of pores per inch, are available with each density providing different strength characteristics. Alternatively, metallic porous filler material manufactured by Recemat International of the Netherlands may be used. Recemat International produces porous filler manufactured from alternative metallic materials such as copper, nickel, and a corrosion resistant nickel-chromium alloy. Please note that the materials described above are merely examples, and equivalent materials may be produced by other manufacturers not listed herein without departing from the scope of the invention.

These porous filler materials or foam cores provide easy of assembly since they may be cut, milled, ground, lapped, drilled and rolled similar to metal. Likewise, porous filler material may be anodized, coated or metal plated for corrosion resistance. The porous filler material can also be brazed to the skin material or adhesively bonded.

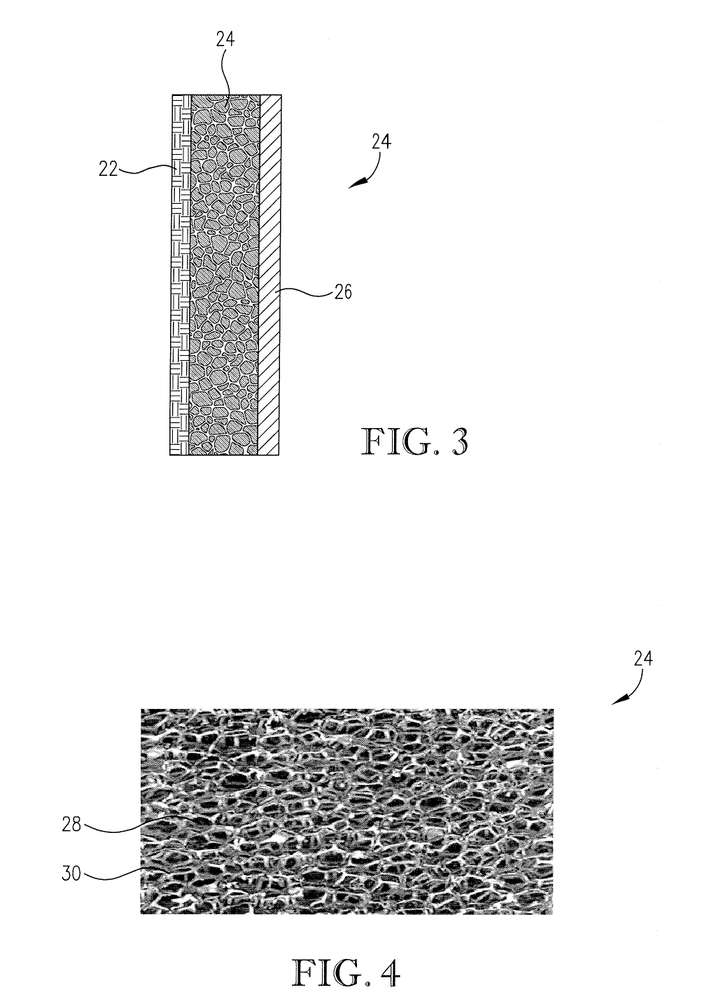

FIG. 3 is a schematic representation of a cross-section of composite forward pressure bulkhead 20 having energy and load distribution layer 22 and porous filler material 24. Energy and load distribution layer 22 is positioned forward so that in the event of a projectile impact such as a bird-strike or other foreign object, the projectile will impact energy and load distribution layer 22. As a projectile impacts composite forward pressure bulkhead 20, the impact energy is distributed without penetrating layer 22 and transferred into porous filler material 24. The sandwich structure is completed by an inboard skin layer 26 comprising a layer of thin aluminum or other composite materials. In one embodiment, composite forward pressure bulkhead utilized Kevlar® composite of 0.040 inch for energy and load distribution layer 22, Duocel® aluminum foam for porous filler material 24 having a thickness of approximately 1.00 inch and finished with inboard skin layer skin layer 26 of aluminum, 7075-T6 of approximately 0.040 inch thick. Thus, this embodiment creates a composite forward pressure bulkhead 20 having an overall thickness of 1.080 inches. This structure is significantly thinner and lighter as compared to traditional forward pressure bulkhead having rib and spar structures.

FIG. 4 is a schematic representation of a cross-section of Duocel® aluminum foam of porous filler material 24 showing open cell 28 and ligament structure 30. Ligament structure 30 creates multiple supports for energy and load distribution layer 22. As energy and load distribution layer 22 deforms under a load or impact, the load or impact energy is transferred to the ligament structure 30 of porous filler material 24. Under over load conditions or impact, ligament structure 30 densifies or crushes resulting in the ligament structure 30 filling open cells 28. This densification process absorbs energy that would have resulted in a failure of the structure. The collapsing of the cells 28 of porous filler material 28 absorbs the impact energy and prevents or reduces the rebound of composite forward pressure bulkhead 20 after compaction. Unlike conventional filler materials and rib and spar design, porous filler material 24 can absorb and dissipate energy from impacts or compression failure. Similarly, under crash conditions that create compressive forces which typically result in buckling of the structure, ligament structure 30 absorbs the energy by collapsing and thereby stops of the transfer of energy along both energy and load distribution layer 22 and inboard skin layer 26 and reduces the severity of buckling. This advantage increases the crash worthiness of the structure.

Another advantage of open cells 28 of porous filler material 24 is that open cells 28 allow any entrapped moisture to wick away from inboard skin layer 26, and travel out of the structure. This reduces the risk or effect of environmental corrosion and prolongs the service life of the bulkhead.

Porous filler material 24 also may assist in the manufacturing of composite forward pressure bulkhead 20. Porous filler material 24 may be used as the lay-up tool for energy and load distribution layer 22 or inboard skin layer 26 when carbon/epoxy composite is utilized. This eliminates the need for a mandrel. Porous filler material 24 may be machined to shape and the carbon/epoxy and/or energy and load distribution layer 22 laid on top of porous filler material 24 for a matched fit. Inboard skin layer 26 may be adhesively bonded after cure or alternatively, adhesive may be applied to porous filler material 24 and energy and load distribution layer 22 and lay-up positioned on porous filler material 24 and the materials co-cured.

Although the invention has been described with reference to the embodiments illustrated in the attached drawings, it is noted that equivalents may be employed and substitutions made herein without departing from the scope of the invention as recited in the claims.

Having thus described an embodiment of the invention, what is claimed as new and desired to be protected by Letters Patent include the following:

1. A composite forward pressure bulkhead for an aircraft comprising:
an energy and load distribution layer;
an inboard skin layer; and
a porous filler material positioned between said energy and load distribution layer and said inboard skin layer.

2. The composite forward pressure bulkhead according to claim 1 wherein said energy and load distribution layer is composed of highly deformable fiber-reinforced composite material that redistributes impact energy without puncture or penetration.

3. The composite forward pressure bulkhead according to claim 2 wherein said energy and load distribution layer is composed of aromatic polyamide fibers.

4. The composite forward pressure bulkhead according to claim 1 wherein said porous filler material contains open cells and ligaments.

5. The composite forward pressure bulkhead according to claim 4 wherein said ligaments collapse in response to a force created by an impact to said energy and load distribution layer or inboard skin layer of said composite forward pressure bulkhead.

6. The composite forward pressure bulkhead according to claim 4 wherein said ligaments collapse in response when said composite forward pressure bulkhead experiences high compression stresses.

7. The composite forward pressure bulkhead according to claim 5 wherein said collapse of said ligaments results in a densification of said porous filler material.

8. The composite forward pressure bulkhead according to claim 6 wherein said collapse of said ligaments results in a densification of said porous filler material.

9. The composite forward pressure bulkhead according to claim 1 wherein said porous filler material is formed of a metallic material.

10. The composite forward pressure bulkhead according to claim 9 wherein said metallic material is one of the group consisting of aluminum, steel, nickel, copper, zinc, lead cobalt, cadmium and alloys thereof.

11. The structural composite element according to claim 1 wherein said inboard skin comprises a metal selected from on of the group of aluminum, steel, nickel, copper, zinc, and alloys thereof.

12. The structural, energy absorbing composite element according to claim 1 wherein said inboard skin comprises a composite material comprised of the group of carbon/epoxy, thermal set materials, thermoplastic materials and metal matrix composite materials.

13. A composite forward pressure bulkhead for an aircraft comprising:
an energy and load distribution layer having high tensile strength and high modulus fiber;
an inboard skin layer; and
a porous filler material having open cells and ligaments positioned within said energy absorbing layer and said inboard skin layer, wherein said ligaments collapse in response to a force created by an impact to said energy absorbing layer or inboard skin layer or when said composite forward pressure bulkhead experiences high compression stresses.

14. The composite forward pressure bulkhead according to claim 13 wherein said energy and load distribution layer absorbs and dissipate energy of a puncture or penetration.

15. The composite forward pressure bulkhead according to claim 13 wherein said collapse of said ligaments results in a densification of said porous filler material.

16. The composite forward pressure bulkhead according to claim 13 wherein said porous filler material is formed of a metallic material.

17. The composite forward pressure bulkhead according to claim 16 wherein said metallic material is one of the group consisting of aluminum, steel, nickel, copper, zinc, lead cobalt, cadmium and alloys thereof.

18. The forward pressure bulkhead according to claim 13 wherein said inboard skin layer comprises a metal selected from on of the group of aluminum, steel, nickel, copper, zinc, and alloys thereof.

18. The composite forward pressure bulkhead according to claim 13 wherein said inboard skin layer comprises a composite material comprised of the group of carbon/epoxy, thermal set materials, thermoplastic materials and metal matrix composite materials.

20. A composite forward pressure bulkhead for an aircraft comprising:
an energy and load distribution layer having high tensile strength and high modulus fiber that absorbs and dissipates energy of a puncture or penetration;
an inboard skin layer; and
a porous filler material insert having open cells and ligaments positioned within said energy absorbing layer and said inboard skin layer, wherein said ligaments collapse resulting in a densification of said porous filler material in response to a force created by an impact to said energy and load distribution layer or said inboard skin or when the composite forward pressure bulkhead experiences high compression stresses.

21. The composite forward pressure bulkhead according to claim 20 wherein said porous filler material is one of the group consisting of aluminum, steel, nickel, copper, zinc, lead cobalt, cadmium and alloys thereof.

22. The composite forward pressure bulkhead according to claim 20 wherein said energy and load distribution layer is composed of aromatic polyamide fibers.

23. The composite forward pressure bulkhead according to claim 20 wherein said inboard skin layer comprises a metal selected from on of the group of aluminum, steel, nickel, copper, zinc, and alloys thereof.

24. The composite forward pressure bulkhead according to claim 20 wherein said inboard skin layer comprises a composite material comprised of the group of carbon/epoxy, thermal set materials, thermoplastic materials and metal matrix composite materials.
